(19) United States
(12) Patent Application Publication
(10) Pub. No.: US 2008/0153482 A1
(43) Pub. Date: Jun. 26, 2008

(54) SEAMLESS SERVICES TO A ROAMING USER EQUIPMENT

(75) Inventor: George Philip Kongalath, St-Laurent (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/615,455

(22) Filed: Dec. 22, 2006

(51) Int. Cl. H04Q 7/20

(52) U.S. Cl. 455/432.1

(57) ABSTRACT

A method and emulating communication node for providing service access in a second network to a roaming user equipment (UE) registered in a first network. The emulating communication node comprises and application server (AS) and a global service interface (GSI). The AS comprises a processing module for operating the AS, interfacing with a global service interface (GSI), receiving from a user equipment (UE) a request including access information of the UE for receiving services when located in a second packet data network, determining the service preferences for the requested service delivery to the UE and applying the determined service preferences to the requested service in the second packet data network. The GSI comprises a processing module for retrieving from an account database a user profile associated to the UE and interfacing the AS and service providers in the first and second networks.

### TECHNICAL FIELD

The invention relates to a method and network for proving packet data service to roaming user equipments (UEs).

### BACKGROUND

Internet Protocol (IP) and broadband high speed technology provide multimedia content such as video and music, which is transmitted over a broadband network to television equipment or other projection equipments. End-users can access multimedia contents for which they have subscribed from a remote point different then their home network. However, the quality of the transmission is very poor and not worth watching.

It is also known in published standards that a mobile subscriber can roam from its home network to a foreign network and receive a phone call or data transmission with the assurance of Quality-of-Service (QoS).

When an end-user signs up for services like IP television (IPTV), it is not possible for that end-user to have the service switched to an alternative endpoint for a predetermined period of time by entering a feature code or going to the web and provisioning the system via a self service portal. Furthermore, if a user is located in a foreign network different than its home network, it is not possible to use a user equipment such as a the set-top box and access the same service that he has subscribed in its home network even though the service provider in the foreign network is different than the service provider of in its home network.

Since multiple networks may be traversed for ultimately providing services to an end-user registered in its home network but located in a foreign network and since electronic negotiation between networks may increase the signaling. The cost for service providers and network operators for providing the cost of roaming may increase significantly. Furthermore, the limitations of inter-network contractual agreements between service providers or network operators for providing an efficient service provision irrespective of a location of an end-user may increase the cost for signaling and network availability, which in the end may also increase significantly the cost of roaming for an end-user.

Therefore, there is a need to provide a solution for providing services to a roaming UE with a same level of service similar as the one provided in its home network. The invention provides a solution to that problem.

### SUMMARY

It is a broad aspect of the present invention to provide a method for providing service access to a roaming user equipment (UE) registered in a first network, the method comprising the steps of:

receiving, at an emulating communication node from the UE, a request for receiving a service when located in a second packet data network, the request including access information of the UE;

validating, at the emulating communication node, the access information of the UE;

retrieving, at the emulating communication node, a user profile associated to the UE;

determining, at the emulating communication node, service preferences for the delivery of the requested service to the UE;

applying the determined service preferences to the requested service in the second packet data network.

It is another broad aspect of the present invention to provide an emulating communication node for providing access to services to a user equipment, the emulating communication node comprising:

an application server (AS) comprising:
a processing module for operating the AS, interfacing with a global service interface (GSI), receiving from a user equipment (UE) a request including access information of the UE for receiving services when located in a second packet data network, determining the service preferences for the requested service delivery to the UE and applying the determined service preferences to the requested service in the second packet data network; and

the global service interface (GSI) comprising:
a processing module for retrieving, from an account database, a user profile associated to the UE.

### BRIEF DESCRIPTION OF THE DRAWINGS

The foregoing and other aspects, features, and advantages of the invention will be apparent from the following more particular detailed description as illustrated in the accompanying drawings in which reference characters refer to the same parts throughout the various views. The drawings are not necessarily to scale, emphasis instead being placed upon illustrating the principles of the invention.

FIG. 1 is a schematic diagram illustrating a packet data network 100 for providing packet data services to a User Equipment (UE) in accordance to the invention;

FIG. 2A is an example of a user account associated to a user of a UE which is stored in a Global Service Interface (GSI) in accordance to the invention;

FIG. 2B is an example of a user profile associated to a UE in accordance to the invention;

FIG. 3 is an example of a table that contains service preferences stored in the repository of an application server (AS) in accordance to the invention;

FIG. 4 illustrates an example of user portal that can be accessed for modifying or scheduling requested services in a packet data network in accordance to the invention;

FIG. 5A a flow chart of a method for providing services to a UE in a foreign network with service preferences defined in an AS in accordance to the invention; and

FIG. 5B a flow chart of a method for scheduling a requested service in accordance to the invention.

### DETAILED DESCRIPTION

In the following description, for purposes of explanation and not limitation, specific details are set forth such as particular architectures, interfaces, techniques. In order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

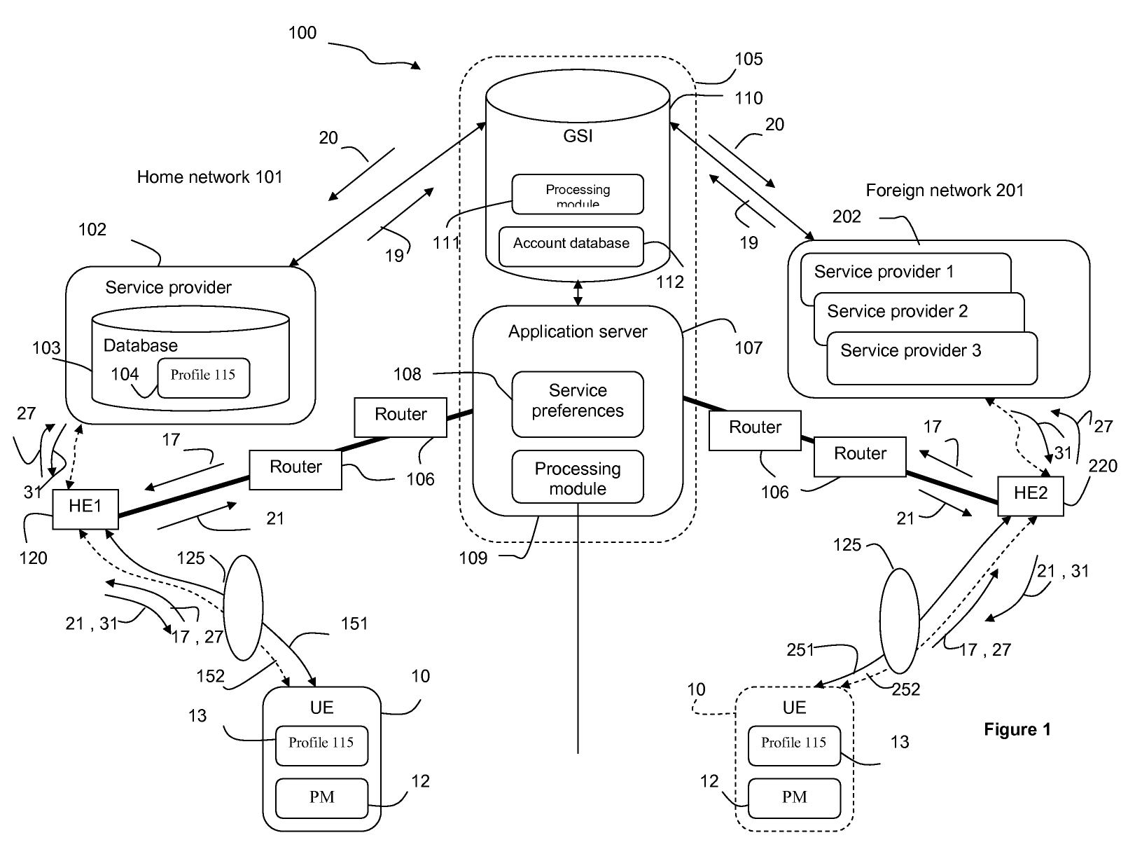

Reference is now made to FIG. 1, which is a schematic diagram illustrating a packet data network 100 for providing packet data services to a User Equipment (UE) in accordance to the invention. The packet data network 100 may be any network that can provide packet data services on a broadband connection to a User Equipment (UE) 10. For instance, the network 100 can be any third generation (3G) network (3GSM, WiMax) or more generally a Universal Mobile telecommunication System (UMTS) network published and defined by the Third partnership project (3GPP) www.3gpgp.org and Third partnership project (3GPP2) www.3gpp.org, optical or broadband network.

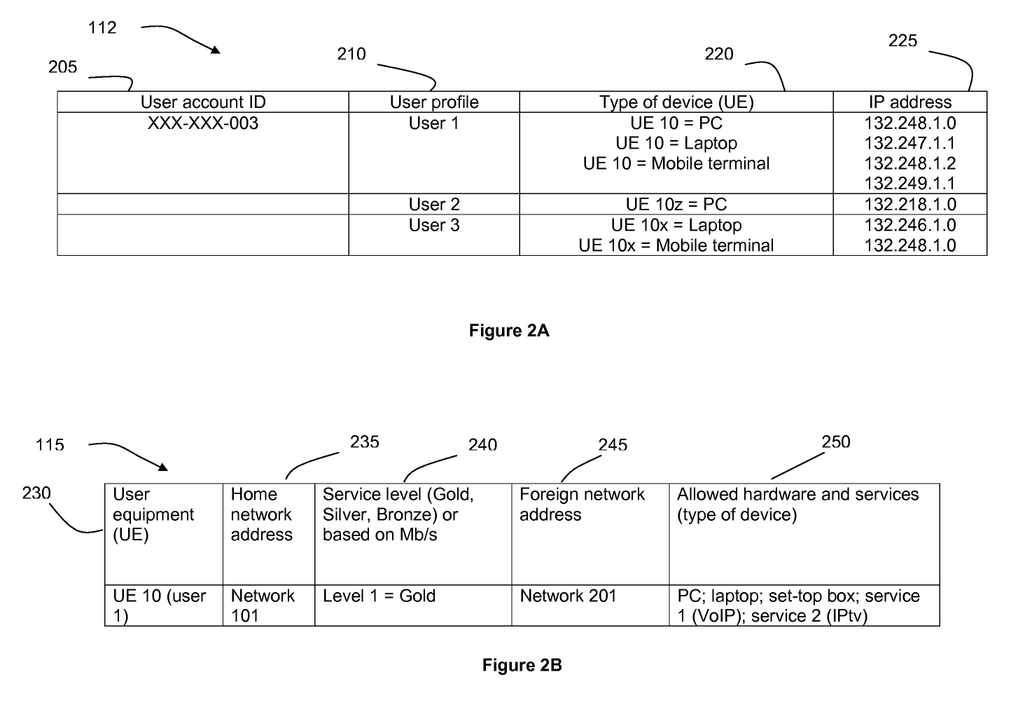

The UE 10 can be any mobile equipment that is adapted to receive packet data services (real-time or non real-time services) such as Voice over Internet Protocol (VoIP) or IPTV. The UE 10 comprises a processing module 12 for receiving and sending information from and to an emulating communication node 105 or other network elements in the network 100. The processing module 12 also operates the UE 10, processes the received information and generates sent messages from the UE 10. The UE 10 also comprises a memory 13 for storing access information such as the profile 115 of the UE 12 that can be accessed by the processing module 12. Reference is now made to FIG. 2B, which illustrates an example of the user profile 115 that can be associated to UE 10. The user profile 115 can comprise, while not being limited to, a UE identifier 230, a home network IP address 235 the service level 240, which is linked to the service preferences and can be accessed by the AS 107, a foreign network IP address 245 and the allowed hardware, which are the allowed types of UEs and service types (VoIP, IPtv, etc) 250.

The UE 10 can be wirelessly connected via link 152 or physically connected via 151 to one of the network elements in its home network 101. The UE 10 can be wirelessly connected via link 252 or physically connected via 251 to one of the network elements in the foreign network 201. In particular, the UE 10 refers to a device (PC, laptop, mobile terminal, set-top box, etc) that is operable on the packet data network 100, or an IPTV network such as an IPTV network defined and supported in European Telecommunications Standards Institute (ETSI)/Telecoms & Internet converged Services & Protocols for Advanced Networks (TISPAN) www.etsi.org. It can be understood that the present invention is not only addressed to IPTV services, but can also be applied, while not being limited to, file transfer (FTP), video streaming, video conference, gaming or Voice over IP (VoIP), e-mail, and it should be clear that any real-time and non real-time packet data service that can be provided by the present network 100 is also encompassed.

The network 100 comprises an emulating communication node 105 for emulating services to the UE 10. The emulating communication node 105 comprises an Application server (AS) 107 for interacting with a requesting entity such as UE 10 and a General Service Interface (GSI) 110 for interacting with services providers of different networks, storing user profiles, managing account associated to user equipment and storing billing information. The AS 107 and the GSI 110 are collocated in FIG. 1, but they can also be used as standalone network elements or combined with another entity of the network 100. The AS 107 and the GSI 110 exchange and update user account 112 information and service preferences 108 information.

In particular, the GSI 110 comprises a processing module for processing module 111 for receiving and sending information through the network 100, operating the GSI 110, generating messages sent from the GSI 110 and interfacing with the AS 107 of the emulating communication node 105 in order to provide a service level to a UE regardless of the location of the UE (home network 101 or foreign network 201). Reference is now made to FIG. 2A, which is an example of a user account 112 associated to a UE 10 identifier, which can be, while not being limited to, an International Mobile Subscriber Identity (IMSI), a username or a Network Access Identifier (NAI) of the UE 10. The user account may contain a home network address 210, a service level 240 defined when adding the profile 115 to the account 112, an identifier (IP address) 225 for each possible type of UE registered in a user profile 210 profile.

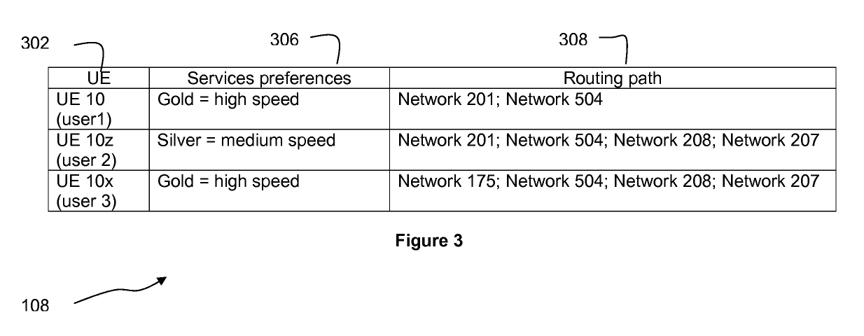

The AS 107 comprises a processing module 108 for receiving and sending information and messages through the network 100, operating the AS 107, generating messages sent from the AS 107 and interfacing with the GSI 110 of the emulating communication node 105. The AS 107 further comprises a service preferences repository 108 for storing information that can be accessed by the processing module 109. Reference is now made to FIG. 3, which is an example of a table that contains service preferences stored in the repository 108. The information stored in the repository 108 related to class of services or bandwidth 306 to be allocated to a particular service for one of the UEs 302 and also to a routing path 308 established between one of the UEs 302 and the emulating communication node 105 and ultimately the AS 107. The AS 107 can be, while not being limited to, a web based application, a dedicated application, a Wireless Application Protocol (WAP) server, a third generation (3G) client like a Subscriber Identity Module (SIM) client or a Session Initiation Protocol (SIP) client.

The repository 108, the account database 112 and the memory 13 may be any persistent memory like a Read-Only Memory (ROM), a Structured Query Language (SQL) database or a Flash memory. The processing modules 13, 109 and 111 can be hardware, software, or any combination thereof.

The network 100 comprises a home network 101 in which the UE 10 has subscribed to services from a service provider 102 and a foreign network 201 in which the UE may roam and obtain same services to which it has subscribed in the home network 101 from a service provider 202 located in the foreign network. Each network may be separated by other networks and comprises at least one service provider. A connection form the UE 10 to the emulating node can be made in an ad hoc manner. In particular, the connection may be made using an optimal routing path 308 through networks between the emulating communication node 105 and the UE 10. The routing path 308 is represented by the routers 106, which are connected via for example DHCP or Ethernet. The routers 106 represent nodes of networks that separate the emulating communication node 105 from the UE 10 in the foreign network 201 or access nodes that separates the UE 10 from the emulating communication node 105 in the home network 101.

When the UE 10 is connected to its service provider 102 a requested service can easily be provided to the UE 10. The service provider 102 has a copy of the profiler 115 stored in its database and when a service such as IPTV is requested through a portal 125 to the emulating node 105, the application server 107 retrieves the service preferences for the UE 10 to be applied to the requested service that will be provided to from the service provider 102. The service provider 102 then retrieves the profile 115 of the UE 10. The requested service is then provided to the UE 10 using a head-end 1 (HE1) 120, which can receive data of broadcasting entity (not shown) that can provide media content to end-users such as Cable News Network (CNN) www.cnn.com. The HE1 120 can be any access node or satellite dish that is wirelessly or physically connected to a service provider, a broadcasting entity and an AS in order to provide the requested service to the UE 10.

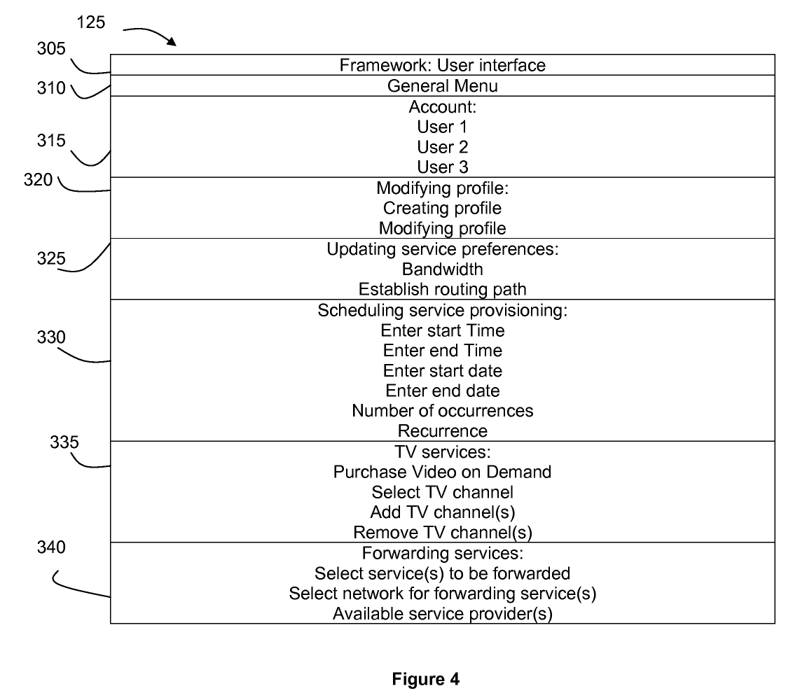

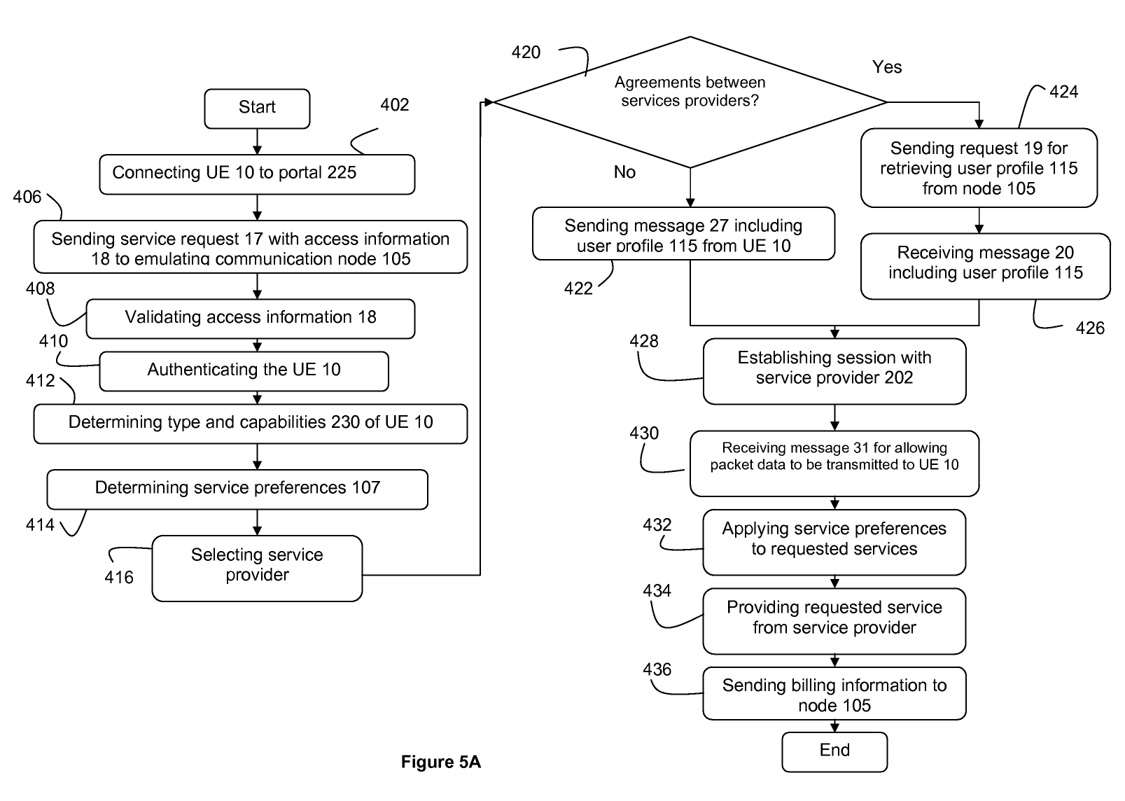

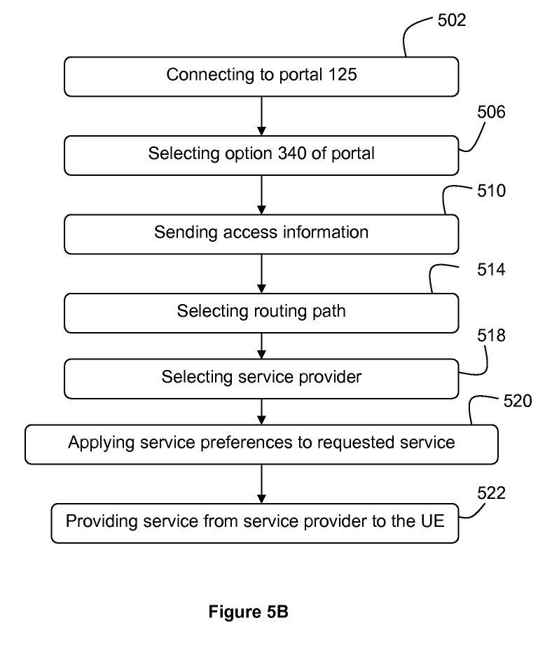

Reference is now made to FIG. 5A, which describes a flow chart of a method for providing services in the foreign network 201 with service preferences provided to the UE 10 by the service provider 102 in the home network 101. When the UE 10 is located in the foreign network 201 and registered with the service provider 102, the UE may access a portal 125 for receiving and modifying services and service preferences. Reference is now made to FIG. 4, which illustrates an example of the portal 125. The portal 125 is a user friendly interface for accessing the service preferences available in the AS 107 when located the foreign network 201. The portal 125 of FIG. 4 is an example of a portal for accessing IPTV services. Therefore it can be understood that the portal 125 may comprise additional options not shown in FIG. 4. The UE 10 accesses the menu of the portal 125 and establishes a routing path between the UE 10 and the AS 107. The portal is a framework that can be a web access web page, an Internet graphical user interface or a web based application 305. The portal 125 allows a user to access an account 315 and different options of a menu 310 from its home network 101 or a remote location such as the foreign network 201 (402). The options allow a user to:

Modify a profile of an account 315 (option 320):
Creating profile
Modifying profile

Updating service preferences (option 325):
Bandwidth
Establish routing path

Scheduling service provisioning (option 330):
Enter start Time
Enter end Time
Enter start date
Enter end date
Number of occurrences
Recurrence

TV services (option 335):
Purchase Video on Demand
Select TV channel
Add TV channel(s)
Remove TV channel(s)

Forwarding services (option 340):
Select service(s) to be forwarded
Select network for forwarding service(s)
Available service provider(s)

At step 406, the UE 10 sends a service request 17 including access information 18 to the emulating communication node 110. The access information 18 consists of credentials such as the identifier and related information for authenticating the user at the AS 107 and ultimately the emulating communication node 105 of the UE 10. The access information 18 may also be used for modifying the profile 115 in the GSI 110. This access information 18 is then processed at the AS 107, which validates the access information 18 (step 408) and authenticates the UE (step 410). The validation is performed by using a table of correspondence such as the table of FIG. 2A, which is an example of a user account 205 having at least one user profile 210 containing the types of UE 220 allowed and associated IP address or ID 225 for the user of the UE 10 or any other UE. During the authentication process (step 410), the AS 107 determines the type of UE 10 and the capabilities 230 of the UE 10 (step 412) and the service preferences 108 (step 414). The UE 10 then accesses the user self provisioning portal 125 for selecting an appropriate service provider from the list of available service providers 202 (service provider 1, service provider 2 or service provider 3) (step 416). It can be understood that each of the service providers 202 comprises a similar database 103 and similar functionalities as shown and as described for service provider 102.

During the selection of the service provider, the emulation communication determines whether a billing agreement or any contractual agreement for providing services exist between the service provider 102 and the selected service provider 202. The UE 10 may also determine whether an agreement exists when an available service provider 202 is not in a list of authorized service providers but is discovered by the UE 10 (step 420). If an agreement exists between the service provider 102 and the selected service provider 202, the selected service provider 202 sends a request 19 to the GSI 110 for retrieving the user profile and determining if the UE 10 is allowed to receive services (step 424). The GSI 110 then confirms that the UE 10 is allowed to receive the requested service and sends to the service provider 202 a message 20 containing the profile 115 of the UE 10 (step 426).

Alternatively, when there is no agreement between the service provider 102 and the selected service provider 202, the UE 10 sends message 27 including its user profile 115 and access information 18 (422). Following this, the service provider 202 sends a message 31 to the UE 10 for informing the UE 10 that a session is established between the UE 10 and the service provider 202 (step 428) and packet data of the requested service are allowed to be transmitted from the service provider 202 to the UE 10 through the HE2 220, which comprises similar functions as describes for HE1 120 (step 430). The AS 107 further applies services preferences to the requested service at the HE2 220 (step 432). The requested service is then provided (step 434) and billing information is sent to the GSI 110 (step 436).

Since a user account 205 has fields for each user profile given for example for each member of a same family of simply to a user that wanted to choose between a plurality of user profiles 210 for a different period of time. A user associated for example to the profile of user 1 in table 112 may to forward services to another location with in the same network and another location outside the home network. Reference is now made to FIG. 5B, which describes a method for forwarding services to a specific location in a home network 101 or a foreign network 201. The service(s) can be forwarded on a scheduled basis or on demand basis. When a service is forwarded the service preferences 108 are modified accordingly to the modification. For example, the service can be forwarded to a secondary house every weekend for a specific time to a specific time, or can be defined ad hoc via the self user provisioning portal 125. One or more services are provided from a service provider for which the user of the UE 10 as subscribed these one or more services.

In the case where the home network is not accessible, an emulation mode will be used in the profile and the serving service provider of the UE for contacting the emulation communication node 105 in order to retrieve the services such as IPTV broadcasting channels from a same media content provider which broadcast a same media content but from different location. More particularly, the GSI 110 informs the serving service provider for providing the look, feel and map it to list of locally available equivalent services at the serving service provider.

A user may wish to schedule its service for transferring the service to another location. Reference is now made to FIG. 5B, which is a flow chart of a method for scheduling a requested service in the home or a foreign network in accordance to the invention. At step 502 the UE 10 first accesses the portal 125. The option 340 of portal 125 is selected and the AS 107 provisions the appropriate control plane elements and signaling for transferring the requested services of a selected service provider 102 in the home network 101 to a service provider 202 of the foreign network 201 at a scheduled time and date (step 506). Then, the switches and routers 106 serving the alternate location, are dynamically provisioned with the user data (profile 115) (step 510), and content servers proxied or connected to the new location e.g. foreign network 201 when necessary. The HE2 220 is dynamically provisioned with the service preference 108 to be applied to the requested service in order to provide the requested service to the UE 10 at the new location. If the location is outside the network (home network 101), a routing path 308 needs to be defined and an automated contract negotiated either at the operator level or the user level for bandwidth and QoS parameters (step 514). This needs to be repeated over multiple networks if the distance between the source and destination is significant.

The accessing device (e.g. UE 10) is provisioned with the appropriate drivers or content interfaces loaded so that the services can be transferred seamlessly. A negotiation is then performed between the UE 10 and the emulating communication node 105 for establishing a cost effective routing path route and pre-arrange payments with the networks between the UE 10 and the emulating communication node 105 (messages 17, 19, 20, 21, 27 and 31). Following this, the service provider 202 is selected from the UE 10 (step 518) and the service preferences are applied to the requested service (step 520). The routing path 308 is then applied in the roaming network 201. The routing path is further specified for providing the services at a defined cost (billing information) (step 522). If pre-paid is involved, access to a rating engine (not shown) to count down and load the system with appropriate funding can be defined in the emulating communication node 205 or elsewhere in network 100. When the UE 10 accesses the requested service during the scheduled time and date the access is similar as if the UE 10 was located in its home network and requesting services to its service provider 102 as defined above in FIG. 5A. The portal 125 remains accessible for the UE 10 when receiving the scheduled requested service. For example, the UE 10 may also choose to access the portal 125 for forwarding its services to another foreign network (not shown) when located in the foreign network 201.

It can be understood that some messages and therefore some parameters sent between network elements of the packet data network 100 are omitted for clarity reasons. Also the messages (17, 19, 21, 27 and 31) can be sent using known technologies such as Short Message Service (SMS), IP Multimedia Subsystem (IMS), Multimedia Messaging Service (MMS) as defined and published by the third generation (3G) partnership project (3GPP) and 3G partnership project 2 (3GPP2). More particularly, it should also be understood that FIG. 1 depict a simplified packet data network 100, and that many other network elements have been omitted for clarity reasons only. Hence, the packet data network 100 may comprise more than the number of network elements present in FIG. 1. In the same line of thought, the packet data network 100 can be accessed by more than one UE and that a plurality of UEs can access simultaneously the packet data network 100. Furthermore, some of the steps on FIGS. 5A and 5B can be performed simultaneously or in a continuous manner to steps defined in FIGS. 5A and 5B.

While the invention has been particularly shown and described with reference to the preferred embodiments thereof, it will be understood by those skilled in the art that various alterations may be made therein without departing from the spirit and scope of the invention.

What is claimed is:

1. A method for providing service access to a roaming user equipment (UE) registered in a first network, the method comprising the steps of:
receiving, at an emulating communication node from the UE, a request for receiving a service when located in a second packet data network, the request including access information of the UE;
validating, at the emulating communication node, the access information of the UE;
retrieving, at the emulating communication node, a user profile associated to the UE;
determining, at the emulating communication node, service preferences for the delivery of the requested service to the UE;
applying the determined service preferences to the requested service in the second packet data network.

2. The method of claim 1, wherein the step of selecting includes a step of determining whether a billing agreement exist between a service provider located in the first network and a service provider located in the second network.

3. The method of claim 2, wherein the method further comprises the steps of:
selecting, through a user provisioning portal, a service provider from a list containing one or more service provider located in the second packet data network;
establishing a routing path for routing information and messages between the UE located in the second packet data network and the emulating communication node;
establishing the session between the UE and the selected service provider;
providing a copy of the UE's user profile from the emulating communication node to the selected service provider, if there is an agreement between the service provider of in the first network and the selected service provider in the second network;
allowing the requested service to be delivered from a head-end to the UE; and
providing the requested service to the UE; and
sending billing information from the selected service provider to the emulating communication node;
storing the billing information in an account database.

4. The method of claim 2, wherein the method further comprises the steps of:
selecting, through a user provisioning portal, a service provider from a list containing one or more service provider located in the second packet data network;
establishing a routing path for routing information and messages between the UE located in the second packet data network and the emulating communication node;
establishing the session between the UE and the selected service provider;
providing a copy of the UE's user profile from the emulating communication node to the selected service provider, if there is no agreement between the service provider of in the first network and the selected service provider in the second network;
allowing the requested service to be delivered from a head-end to the UE; and
providing the requested service to the UE; and
sending billing information from the selected service provider to the emulating communication node;
storing the billing information in an account database.

5. The method of claim 1, wherein the step of validating further includes the steps of:
determining, at the emulating communication node, the type and capabilities of the UE; and
determining that the type UE is allowed and capable of receiving the requested service.

6. The method of claim 5, wherein the method further comprises the steps of:
defining an account in an account database, the account containing one or more user profiles for the account in which the UE is registered; and
modifying the account in which the UE is registered, the modification consisting of:
a) registering a user to the account;
b) removing a user profile to the account; and
c) modifying service preferences for at least one user profile of the account.

7. The method of claim 1, wherein the method further comprises a step of forwarding the requested service from the first network to the second network.

8. The method of claim 7, wherein the wherein the UE schedules in the first network a delivery of service from the emulating node to a location in the second network.

9. The method of claim 7, wherein the wherein the user equipment establishes in the first network a routing path between the emulating communication node and a location in the second network.

10. The method of claim 1, wherein the method further comprises a step of forwarding the requested service from the second network to a further network.

11. The method of claim 1, wherein the service is an Internet Protocol television (IPTV) service.

12. The method of claim 1, wherein the requested service is a file transfer protocol (FTP) service.

13. The method of claim 1, wherein the requested service is a video streaming service.

14. The method of claim 1, wherein the requested service is a non-streaming service.

15. The method of claim 1, wherein the requested service is a real-time service.

16. An emulating communication node for providing access to services to a user equipment, the emulating communication node comprising:
an application server (AS) comprising:
a processing module for operating the AS, interfacing with a global service interface (GSI), receiving from a user equipment (UE) a request including access information of the UE for receiving services when located in a second packet data network, determining the service preferences for the requested service delivery to the UE and applying the determined service preferences to the requested service in the second packet data network; and
the global service interface (GSI) comprising:
a processing module for retrieving, from an account database, a user profile associated to the UE.

17. The emulating communication node of claim 16, wherein the processing module of the AS establishes a connection between the UE and a service provider from the one or more service providers located in the second packet data network.

18. The emulating communication node of claim 16, wherein the processing module of the AS further establishes a routing path for routing information and messages between the UE located in the second packet data network and the emulating communication node and establishes a session between the UE and the selected service provider.

19. The emulating communication node of claim 16, wherein the processing module of the AS further determines the type and capabilities of the UE and determines that the type UE is allowed and capable of receiving the requested service.

20. The emulating communication node of claim 16, wherein the processing module of the AS further forwards the requested service from the first network to the second network.

21. The emulating communication node of claim 16, wherein the wherein the UE schedules in the AS a delivery of the requested service from the emulating node to a location in the second network.

22. The emulating communication node of claim 16, wherein the processing module of the AS establishes in the first network a routing path between the emulating communication node and a location in the second network.

23. The emulating communication node of claim 16, wherein the processing module of the AS further forwards the requested service from the first network to a further network.

24. The emulating communication node of claim 16, wherein the UE selects, through a user provisioning portal, a service provider from a list containing one or more service providers located in the second packet data network.

25. The emulating communication node of claim 16, wherein the UE determines that a billing agreement exists between a service provider located in the first network and a service provider located in the second network.

26. The emulating communication node of claim 16, wherein the processing module of the GSI further providing a copy of the UE's user profile from the emulating communication node to the selected service provider, if there is no agreement between the service provider of in the first network and the selected service provider in the second network, receives billing information from the selected service provider to the emulating communication node and stores the billing information in an account database.

27. The emulating communication node, wherein the processing module of the GSI determines that a billing agreement exists between a service provider located in the first network and a service provider located in the second network.

28. The emulating communication node of claim 16, wherein the processing module of the GSI further provides providing a copy of the UE's user profile from the emulating communication node to the selected service provider, if there is an agreement between the service provider of in the first network and the selected service provider in the second network, receives billing information from the selected service provider to the emulating communication node and stores the billing information in the account database.

29. The emulating communication node of claim 16, wherein the processing module of the GSI further:
defines an account in an account database, the account containing one or more user profiles for the account in which the UE is registered; and
modifies the account in which the UE is registered, the modification consisting of:
a) registering a user to the account
b) removing a user profile to the account; and
c) modifying service preferences for at least one user profile of the account.
